(19) United States
(12) Patent Application Publication
(10) Pub. No.: US 2021/0184479 A1
(43) Pub. Date: Jun. 17, 2021

(54) VEHICLE CHARGING SYSTEM, PARKING LOT SYSTEM AND VEHICLE CHARGING METHOD

(71) Applicant: NEC Corporation, Tokyo (JP)

(72) Inventors: Yuichiro FUKUBAYASHI, Tokyo (JP); Yasuaki KONDO, Tokyo (JP)

(73) Assignee: NEC Corporation, Tokyo (JP)

(21) Appl. No.: 16/079,531

(22) PCT Filed: Mar. 8, 2017
(86) PCT No.: PCT/JP2017/009302

§ 371 Date: Aug. 23, 2018

(30) Foreign Application Priority Data
Mar. 16, 2016 (JP) 2016-052565

(51) Int. Cl. H02J 7/00; H02J 7/32; H02J 7/16

(52) U.S. Cl. CPC H02J 7/0048; H02J 7/16; H02J 7/32; H02J 7/0069

(57) ABSTRACT

A vehicle charging system includes a non-contact charging apparatus that performs non-contact charging on a battery in a vehicle by facing a power receiving coil mounted on the vehicle; state-of-charge acquisition part configured to acquire a state-of-charge of batteries in a plurality of vehicles; and a charging control apparatus that selects at least one vehicle from the plurality of vehicles on the basis of the state-of-charge, moves the charging apparatus and/or the vehicle, and controls the charging operation of the charging apparatus.

### CROSS-REFERENCE TO RELATED APPLICATIONS

This application is a national stage application of International Application No. PCT/JP2017/009302 entitled “Vehicle Charging System, Parking Lot System and Vehicle Charging Method” filed on Mar. 8, 2017, which claims priority to Japanese Patent Application No. 2016-052565 filed on Mar. 16, 2016, the disclosures of which are hereby incorporated by reference in their entirety.

### FIELD

### Reference to Related Application

The present invention is based upon and claims the benefit of the priority of Japanese patent application No. 2016-052565 filed on Mar. 16, 2016, the disclosure of which is incorporated herein in its entirety by reference thereto.

The present invention relates to a vehicle charging system, parking lot system, and vehicle charging method, and particularly to a vehicle charging system, parking lot system, and vehicle charging method that perform non-contact charging on a rechargeable battery in a vehicle.

### BACKGROUND

In recent years, methods for performing non-contact charging on a rechargeable battery in a vehicle have been examined. For instance, Patent Literatures 1 to 3 disclose systems in which non-contact charging apparatuses are provided on the road and in parking lots and vehicles are moved to the charging spaces where the charging apparatuses are provided and charged. For instance, Patent Literature 1 discloses a system in which a power receiving part 21 for receiving power supply by electromagnetic induction from a power-supply part 31 embedded in the road surface of a parking space 3 is provided in the bottom surface of a vehicle 2 so that the vehicle 2 can be charged while parking.

Patent Literature 4 discloses a system in which a vehicle can be charged while being parked in a mechanical parking lot.

### [Patent Literature 1]

Japanese Patent Kokai Publication No. JP-P2010-226945A

### [Patent Literature 2]

International Publication Number WO2012/042902A1

### [Patent Literature 3]

Japanese Patent Kokai Publication No. JP-P2013-34369A

### [Patent Literature 4]

Japanese Patent Kokai Publication No. JP-P2013-110877A

### SUMMARY

The following analysis is given by the present invention. The charging systems of Patent Literatures 1 to 3 have a problem that, until a vehicle that has finished charging leaves the charging space, a next vehicle cannot be charged. The parking lot system of Patent Literature 4 does not have such an issue, however, a second high frequency wireless power transmission device (also known as a transducer) and a first high frequency wireless power transmission device must be installed in the parking building and at a vehicle parking base, respectively, increasing the installation cost.

It is an object of the present invention to provide a vehicle charging system, parking lot system, and vehicle charging method that can contribute to improving the efficiency of a charging system that charges a plurality of vehicles using the non-contact charging apparatus.

According to a first aspect, there is provided a vehicle charging system comprising a non-contact charging apparatus that performs non-contact charging on a rechargeable battery of a vehicle by facing a power receiving coil mounted on the vehicle. The vehicle charging system further includes a state-of-charge acquisition part configured to acquire a state-of-charge of rechargeable batteries in a plurality of vehicles. The vehicle charging system further includes a charging control apparatus that selects a vehicle to be charged from the plurality of vehicles on the basis of the state-of-charge, moves the charging apparatus and/or the vehicle to a location where the vehicle can be charged by the charging apparatus, and controls the charging operation of the charging apparatus.

According to a second aspect, there is provided a parking lot system comprising a non-contact charging apparatus that performs non-contact charging on a rechargeable battery of a vehicle by facing a power receiving coil mounted on the vehicle; a vehicle moving part configured to move a parked vehicle; a state-of-charge acquisition part that acquires a state-of-charge of rechargeable batteries in a plurality of vehicles; and a charging control apparatus that selects a vehicle to be charged from the plurality of vehicles on the basis of the state-of-charge, moves the vehicle to a location where the vehicle can be charged by the charging apparatus, and controls the charging operation of the charging apparatus.

According to a third aspect, there is provided a vehicle charging method comprising having a non-contact charging apparatus that performs non-contact charging on a rechargeable battery of a vehicle by facing a power receiving coil mounted on the vehicle and a charging control apparatus capable of changing the relative position thereof with respect to the vehicle acquire a state-of-charge of rechargeable batteries in a plurality of vehicles; having the charging apparatus and the charging control apparatus select a vehicle to be charged from the plurality of vehicles on the basis of the state-of-charge; and having the charging apparatus and the charging control apparatus move the charging apparatus and/or the vehicle to a location where the vehicle can be charged by the charging apparatus, and control the charging operation of the charging apparatus. The present method is tied to a particular machine, namely, the vehicle charging system that performs non-contact charging on a plurality of vehicles.

The meritorious effects of the present invention are summarized as follows.

According to the present invention, the efficiency of the charging operation of a charging system that charges a plurality of vehicles using a non-contact charging apparatus can be improved. Namely, the present invention can transform a charging system into a charging system that can charges a plurality of vehicles using a non-contact charging apparatus, with high efficiency.

### BRIEF DESCRIPTION OF THE DRAWINGS

FIG. 1 is a drawing illustrating the configuration of an exemplary embodiment of the present disclosure.

FIG. 2 is a drawing for explaining the operation of an exemplary embodiment of the present disclosure.

FIG. 3 is a drawing for explaining the operation of an exemplary embodiment of the present disclosure.

FIG. 4 is a drawing for explaining the operation of an exemplary embodiment of the present disclosure.

FIG. 5 is a drawing showing a modified configuration of an exemplary embodiment of the present disclosure.

FIG. 6 is a drawing showing the configuration of a vehicle charging system of a first exemplary embodiment of the present disclosure.

FIG. 7 is a drawing for explaining the operation of the vehicle charging system of the first exemplary embodiment of the present disclosure.

FIG. 8 is a drawing for explaining an example of vehicle charging sequence in the vehicle charging system of the first exemplary embodiment of the present disclosure.

FIG. 9 is a drawing for explaining another example of vehicle charging sequence in the vehicle charging system of the first exemplary embodiment of the present disclosure.

FIG. 10 is a drawing showing the configuration of a vehicle charging system of a second exemplary embodiment of the present disclosure.

FIG. 11 is a drawing for explaining the operation of the vehicle charging system of the second exemplary embodiment of the present disclosure.

FIG. 12 is a drawing for explaining an example of vehicle charging sequence in the vehicle charging system of the second exemplary embodiment of the present disclosure.

FIG. 13 is a drawing showing the configuration of a vehicle charging system of a third exemplary embodiment of the present disclosure.

FIG. 14 is a drawing showing an example of parking time management information held by the vehicle charging system of the third exemplary embodiment of the present disclosure.

FIG. 15 is a drawing showing another example of the parking time management information held by the vehicle charging system of the third exemplary embodiment of the present disclosure.

FIG. 16 is a drawing showing yet another example of the parking time management information held by the vehicle charging system of the third exemplary embodiment of the present disclosure.

### PREFERRED MODES

First, a summary of an exemplary embodiment will be given with reference to the drawings. Note that drawing reference signs in the summary are given to each element as an example solely to facilitate understanding for convenience and are not intended to limit the present disclosure to the aspects shown in the drawings. Further, connection lines between blocks in the drawings used in the description below can be both bidirectional and unidirectional. Unidirectional arrows schematically indicate main flows of signals (data) and do not exclude bidirectionality. In addition, although there are ports or interfaces at the connection points of the input and output of each block in the figures, they are omitted.

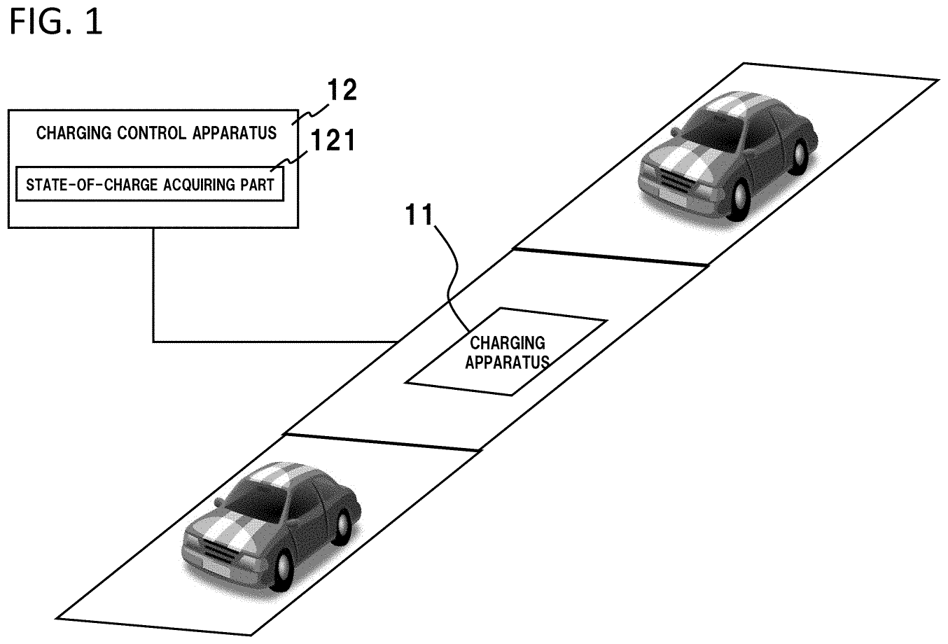

The present disclosure in an exemplary embodiment thereof can be realized by a vehicle charging system including a non-contact charging apparatus 11 that performs non-contact charging on a rechargeable battery of a vehicle by facing a power receiving coil mounted on the vehicle, a state-of-charge acquisition part 121 configured to acquire a state-of-charge of rechargeable batteries in a plurality of vehicles, and a charging control apparatus 12, as shown in FIG. 1.

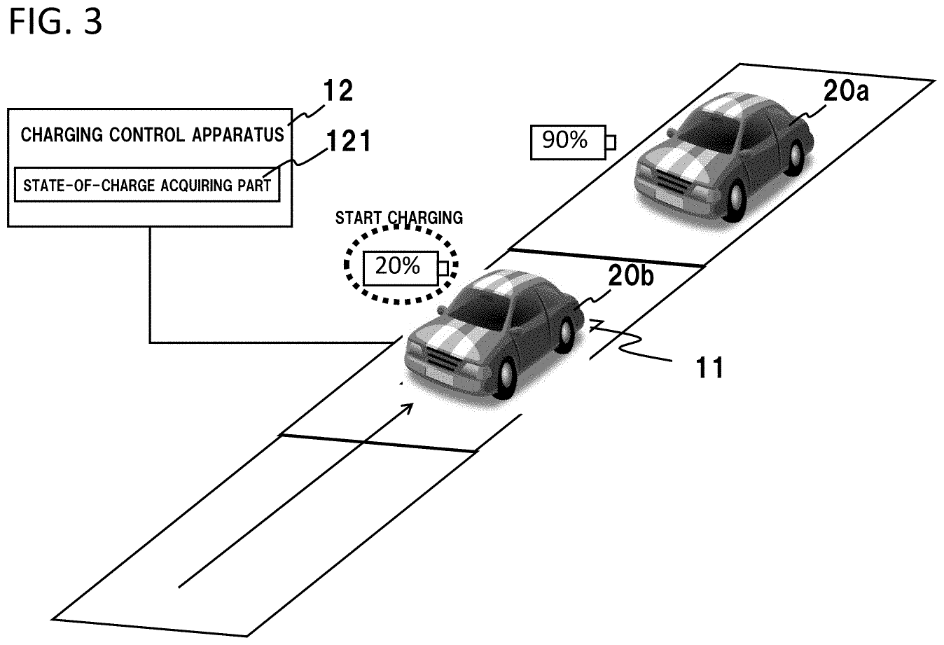

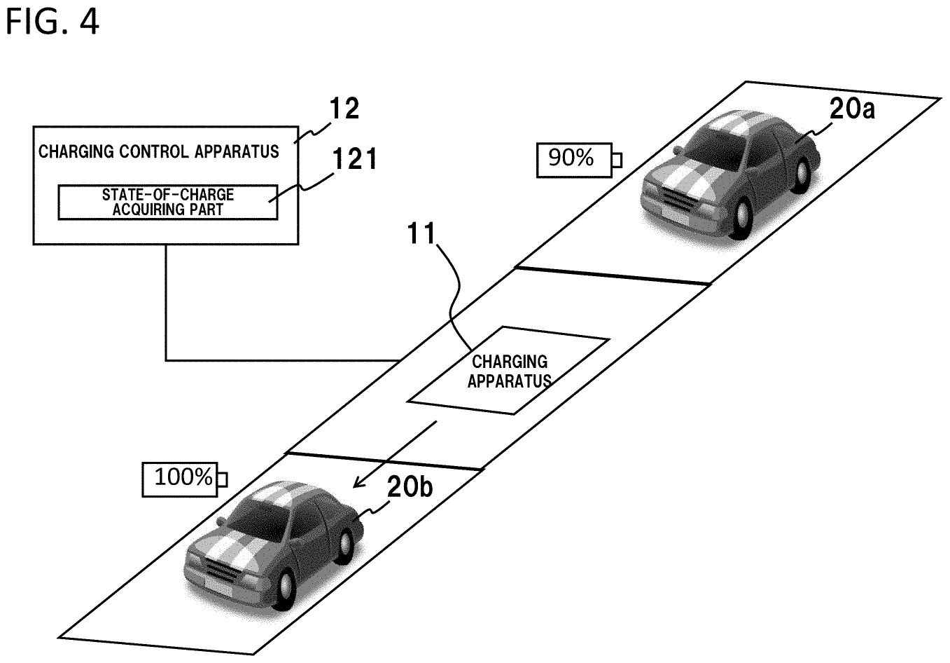

More concretely, the charging control apparatus 12 selects at least one vehicle from the plurality of vehicles on the basis of the state-of-charge acquired by the state-of-charge acquisition part 121. Then the charging control apparatus 12 moves the charging apparatus 11 and/or the vehicle to a location (charging space) where the vehicle can be charged by the charging apparatus 11. In an example shown in FIG. 3, a vehicle having a lower battery charge value (State of Charge=20%; 100% means that the battery is fully charged) is placed in the charge space so that it can be charged first. When the vehicle has been placed in a location where the charging apparatus 11 is able to charge it, the charging control apparatus 12 controls the charging operation of the charging apparatus. Further, after the selected vehicle has been charged, the charging control apparatus 12 immediately moves the charged vehicle out of and away from the charging space, as shown in FIG. 4. Then, the charging control apparatus 12 is able to select another vehicle to be charged. It goes without saying that the operation described above may be repeated until the state-of-charge of all vehicles reaches a predetermined value.

As described above, a single charging apparatus 11 is able to efficiently charge several vehicles. As for the method used by the state-of-charge acquisition part 121 to acquire the state-of-charge of a rechargeable battery in a vehicle, the state-of-charge of the rechargeable battery may be acquired via the charging apparatus 11. The method for acquiring the state-of-charge of a rechargeable battery in a vehicle is not limited thereto, and the state-of-charge acquisition part 121 may directly acquire the information by communicating with a communication apparatus of the vehicle or acquire it from an external vehicle condition management server (vehicle management cloud). In any of these cases, the source that provides the state-of-charge of a rechargeable battery in a vehicle may request a predetermined authentication procedure from the state-of-charge acquisition part 121.

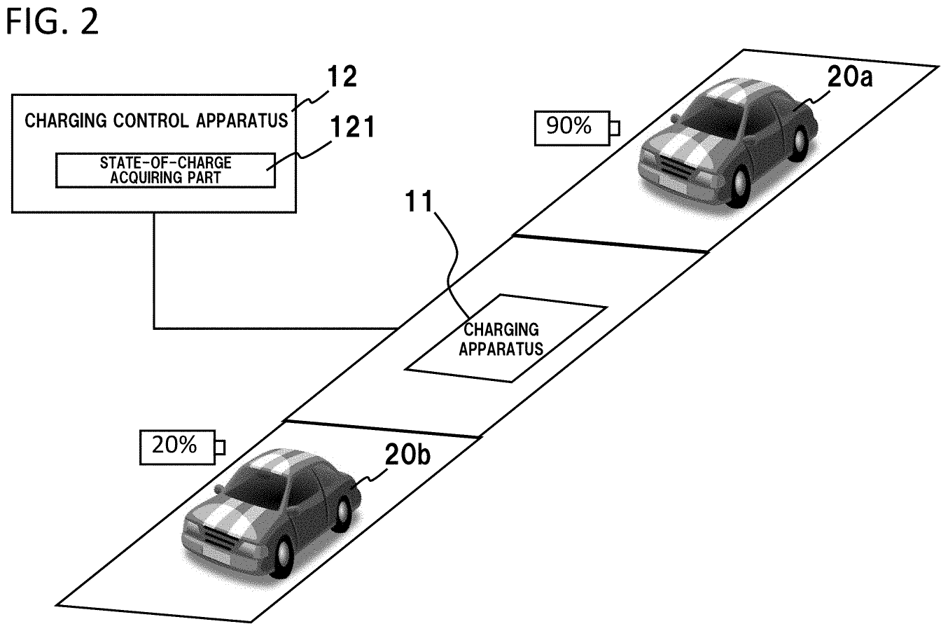

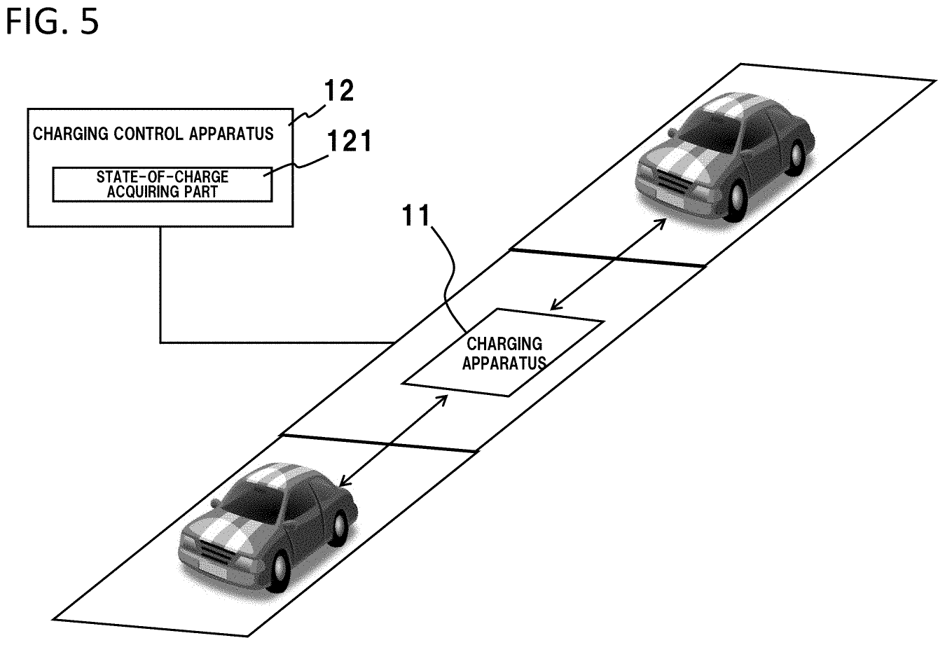

In the example of FIGS. 1 to 4, the vehicles are moved to the space where the charging apparatus 11 is provided by moving pallets on which the vehicles are mounted, however, as shown in FIG. 5, the charging apparatus 11 may be moved. In the case of FIG. 5, however, since the length of a cable supplying power to a power transmission coil in the charging apparatus 11 and the weight thereof may cause restrictions, the system of FIGS. 1 to 4 is preferred when many vehicles are charged.

Further, the systems of FIGS. 1 to 5 have the pallets on which the vehicles are mounted or the charging apparatus 11 reciprocate, however, the pallets or the charging apparatus 11 may be moved in order in the direction in which the vehicles are lined up. For instance, a plurality of vehicles may be sequentially charged by moving the pallets in sequence with the upper right space and the lower left space in FIGS. 1 and 5 as the start and end points of the charging queue, respectively. Further, a single charging apparatus 11 charges one vehicle in the examples of FIGS. 1 and 5, however, a plurality of the charging apparatuses 11 may be provided in parallel to charge a plurality of vehicles simultaneously. In other words, the number of the charging apparatus is not limited to one.

Further, in the present description, “acquisition” includes active acquisition and passive acquisition. Examples of active acquisition include an apparatus acquiring data or information stored in another apparatus or a storage medium, e.g., receiving data or information after sending a request or inquiry to another apparatus and accessing another apparatus or a storage medium to read data or information. Examples of passive acquisition include at least one of the following: an apparatus receiving data or information outputted by another apparatus (passive reception) or receiving distributed (or transmitted, push-notified, etc.) data or information. Further, active acquisition includes acquiring data or information by selecting it from received data or information, and passive acquisition includes receiving distributed data or information by selecting it.

### Exemplary Embodiment 1

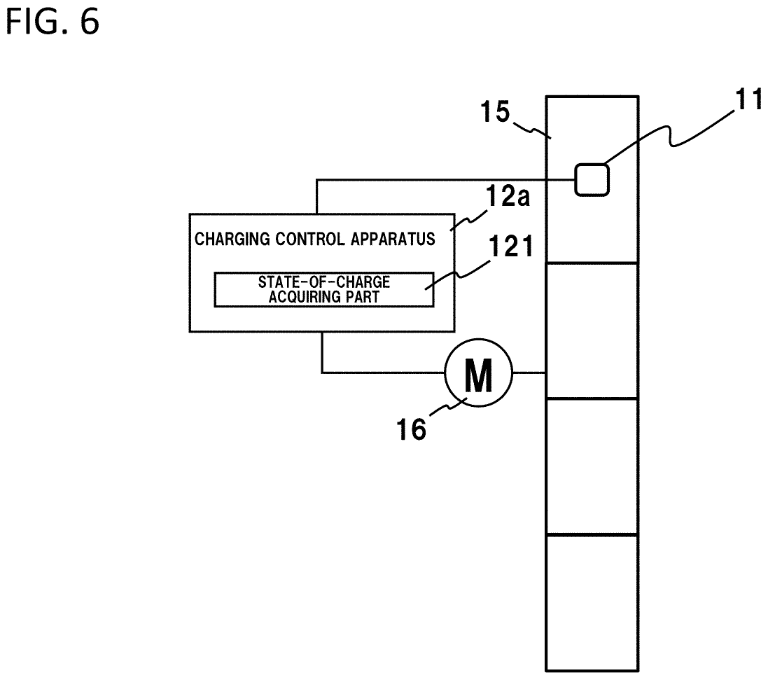

Next, a first exemplary embodiment of the present disclosure will be described in detail with reference to the drawings. FIG. 6 is a drawing showing the configuration of a vehicle charging system of the first exemplary embodiment of the present disclosure. FIG. 6 shows a configuration in which the charging apparatus 11 provided underneath a pallet 15 is connected to a charging control apparatus 12a. Hereinafter, a space where the charging apparatus 11 is provided will be referred to as a charging space.

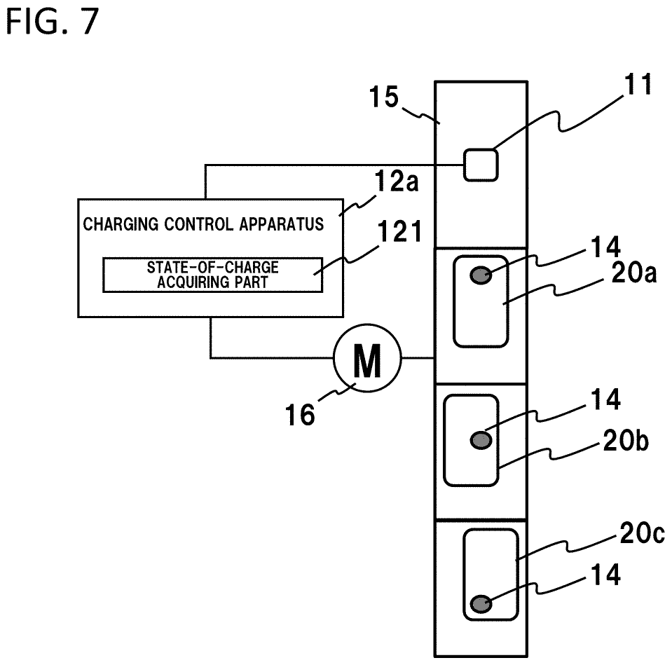

The charging apparatus 11 is a non-contact charging apparatus that performs non-contact charging on a rechargeable battery of a vehicle by facing a power receiving coil (charging port) (refer to reference sign 14 in FIGS. 7 to 9) mounted on the vehicle. Note that the non-contact charging method is not particularly limited and it may be for instance an electromagnetic induction or resonance method. When a resonance method is employed, power transmission from the power transmission coil inside the charging apparatus 11 to the power receiving coil 14 is achieved by resonance coupling between a circuit in the power transmission coil and a circuit in the power receiving coil. More concretely, for instance, a power transmission resonant circuit is formed with a capacitor on the power transmission coil side and a power receiving resonant circuit is formed with a capacitor on the power receiving coil side. The power transmission and power receiving sides should have the same resonant frequency, achieving resonance coupling between the resonant circuits on the power transmission and power receiving sides with this resonant frequency. As a result, the charging apparatus 11 is able to transmit power to the vehicle without having the power transmission coil and the power receiving coil mechanically contact each other.

The charging control apparatus 12a moves a vehicle to the charging space by driving pallet moving part 16 constituted by a motor and has the power receiving coil of the vehicle and the power transmission coil of the charging apparatus 11 electromagnetically coupled to each other. Further, the charging control apparatus 12a controls the charging operation by transmitting a charge start signal or charge end signal to the charging apparatus 11.

The charging control apparatus 12a further comprises the state-of-charge acquisition part 121 configured to acquire the state-of-charge of a battery in a charging target candidate vehicle. The charging control apparatus 12a selects a vehicle to be charged from a plurality of vehicles on the basis of the state-of-charge received from the state-of-charge acquisition part 121 and moves the vehicle to the charging space.

The pallet 15 is a vehicle parking base capable of moving with a vehicle mounted thereon. As the pallet 15, in addition to rectangular one shown in FIG. 6, various types such as a pallet that supports only the wheel parts can be used. Further, a method without using pallets such as moving a vehicle with a comb-shaped arm instead of a pallet can be used as another vehicle moving part.

Next, the operation of the present exemplary embodiment will be described in detail with reference to the drawings. As shown in FIG. 7, it is assumed that three vehicles 20a to 20c are parked one at a time in succession in the description below.

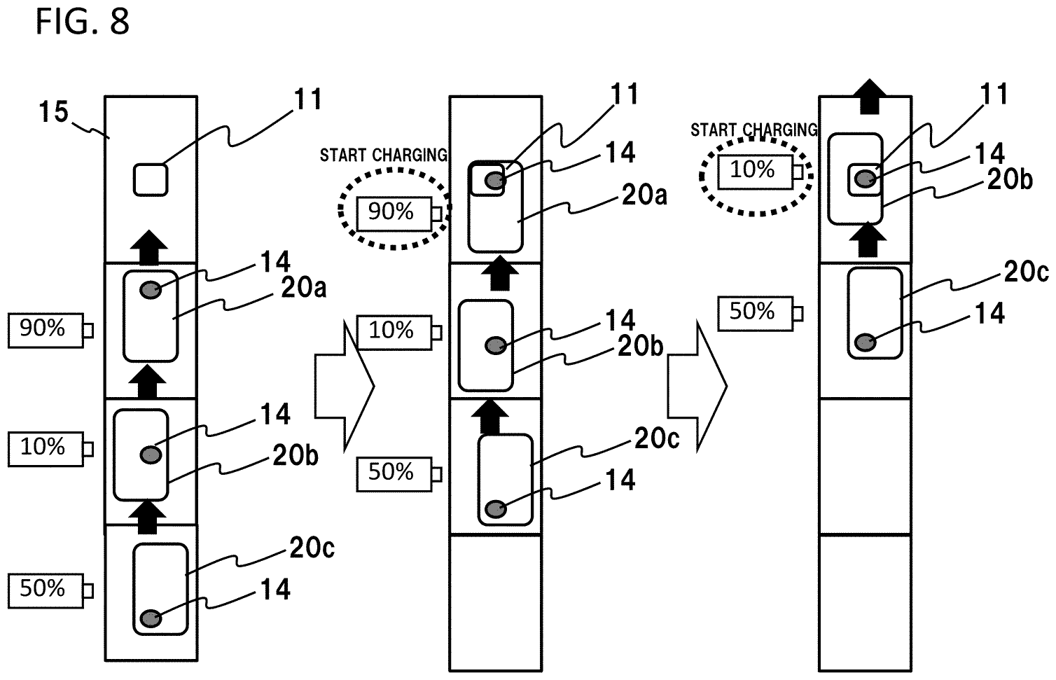

As shown in FIG. 8, the state-of-charge acquisition part 121 first confirms the state-of-charge of the three vehicles 20a to 20c. In the description below, SOC denotes state-of-charge and it is assumed that the SOC values of the vehicles 20a, 20b, and 20c are 90%, 10%, 50%, respectively. Further, in the description below, a SOC in which the vehicle cannot be charged anymore (i.e., full charge state) is 100%, the value decreases as the vehicle discharges, and a state in which the vehicle cannot discharge anymore is 0%.

On the basis of the obtained SOC, the charging control apparatus 12a determines that the vehicle 20a having the SOC of 90% needs to be charged and moves the vehicle 20a to the charging space by driving the pallet moving part 16, as shown in the left and center drawings of FIG. 8. As soon as the vehicle 20a has been moved, the charging control apparatus 12a transmits a charge start signal to the charging apparatus 11, instructing it to charge the battery of the vehicle 20a.

Then, after the vehicle 20a has been charged, the charging control apparatus 12a transmits a charge end signal to the charging apparatus 11. Next, the charging control apparatus 12a moves the vehicle 20a to an exit space not shown in FIG. 8 by driving the pallet moving part 16. Then the charging control apparatus 12a sequentially moves the vehicles 20b and 20c to the charging space to charge the vehicles (refer to the center and right drawings of FIG. 8).

As described, according to the vehicle charging system of the present exemplary embodiment, it is possible to not only select a vehicle to be charged on the basis of SOC, but also move a fully charged vehicle out of the charging space. As a result, a situation in which a vehicle cannot be charged because a fully charged vehicle is occupying the charging space can be prevented.

Further, in the example of FIG. 8, the charging control apparatus 12a sequentially moves the vehicles 20a to 20c to the charging space, however, it may be determined that a vehicle having a SOC value higher than a predetermined threshold does not need to be charged and does not get moved to a parking space.

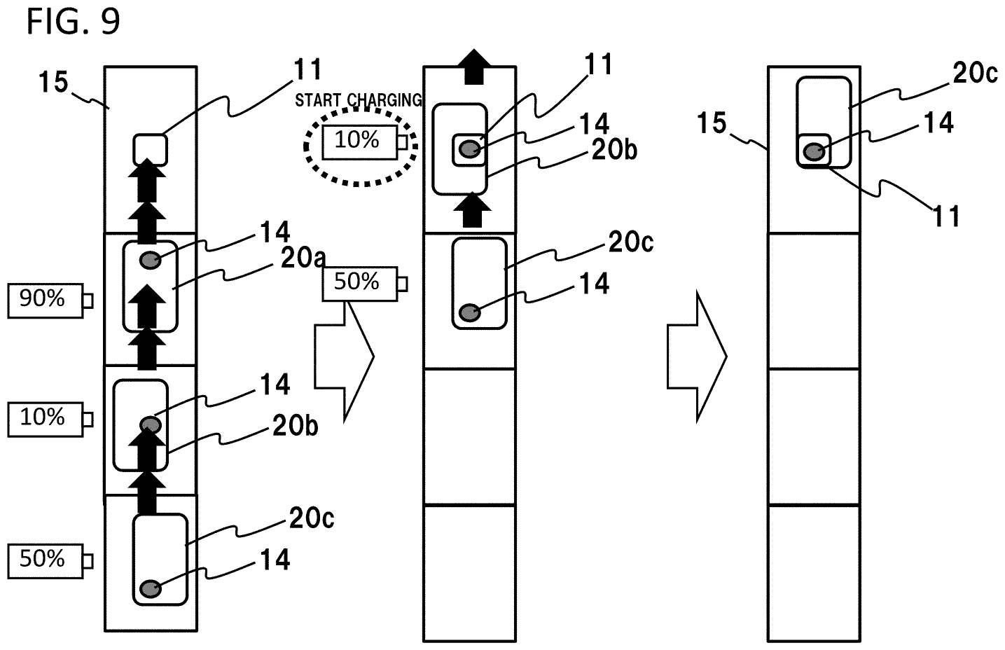

For instance, if a rule of not charging a vehicle with a SOC value higher than a predetermined threshold of 80% is implemented, the vehicle 20a, out of the vehicles 20a to 20c, having a SOC higher than 80% does not have to be charged, as shown in FIG. 9.

Further, the necessity of charging may be determined by a factor other than SOC values. For instance, if the vehicle charging system also acts as a parking lot, vehicles with early arrival and scheduled departure times may be charged first, using arrival time (parking start time) and scheduled departure time. Scheduled departure time may be estimated from the parking fee payment status or location or behavior information of the driver.

Further, if the setting information of the vehicle configured by the owner can be accessed, the necessity of charging may be determined by whether or not the vehicle's driver or owner subscribes to a service that allows him to charge the vehicle outside or by conditions set by the driver or owner. As the conditions set by the driver or owner, those reflecting the intention of the driver or owner, for instance, whether or not the charging cost per unit is within a predetermined amount or whether or not the expected charging time is within a predetermined period of time, can be used. Some of these conditions will be briefly explained in exemplary embodiments described later.

### Exemplary Embodiment 2

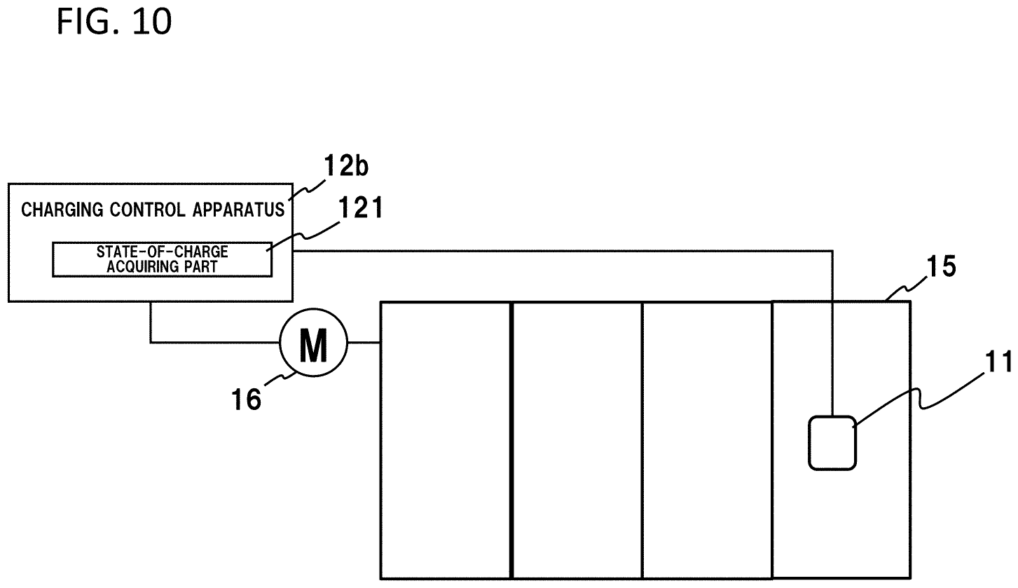

Next, a second exemplary embodiment in which the feed direction of vehicles is changed from the driving direction to the lateral direction in relation to the driving direction of the vehicles will be described in detail with reference to the drawings. FIG. 10 is a drawing showing the configuration of a vehicle charging system of the second exemplary embodiment of the present disclosure. FIG. 10 shows a configuration in which the charging apparatus 11 provided underneath the pallet 15 is connected to a charging control apparatus 12b. Since the second exemplary embodiment is the same as the first exemplary embodiment except that the parking direction of vehicles is changed along with the feed direction thereof, the differences will be mainly described.

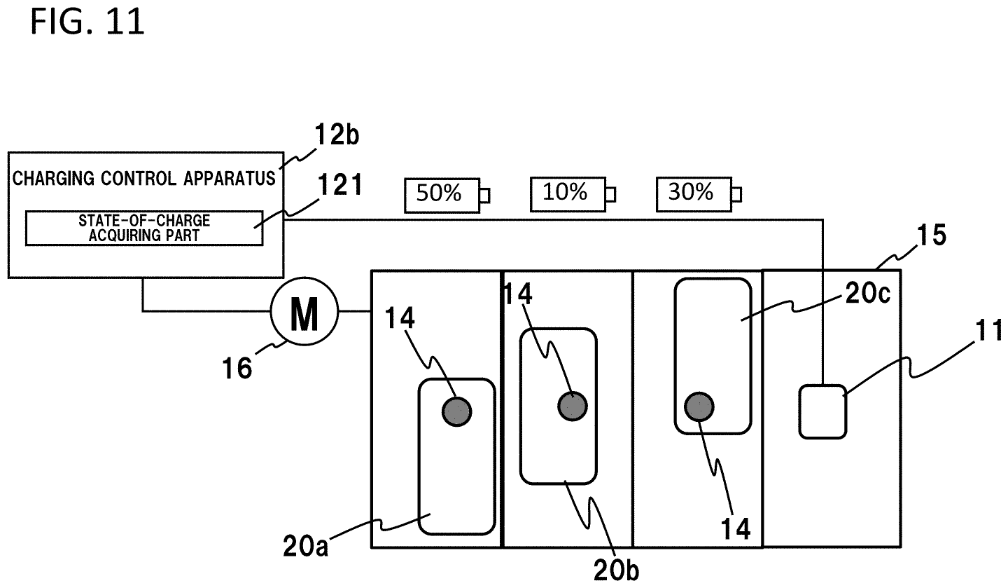

It is assumed that the state-of-charge acquisition part 121 has acquired SOC of three vehicles 20a to 20c in an initial state, as shown in FIG. 11. In the description below, SOC denotes state-of-charge and it is assumed that the SOC values of the vehicles 20a, 20b, and 20c are 50%, 10%, 30%, respectively.

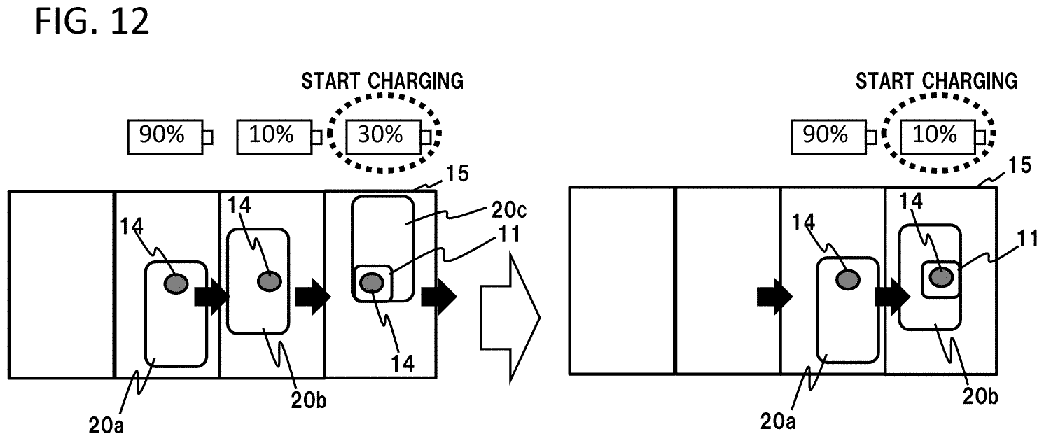

The operation of the present exemplary embodiment is the same as that of the first exemplary embodiment, and the charging control apparatus 12b determines that the vehicle 20c having the SOC of 30% needs to be charged on the basis of the obtained SOC and first moves the vehicle 20c to the charging space by driving the pallet moving part 16, as shown in the left drawing of FIG. 12. As soon as the vehicle 20c has been moved, the charging control apparatus 12b transmits a charge start signal to the charging apparatus 11, instructing it to charge the battery of the vehicle 20c.

Then, after the vehicle 20c has been charged, the charging control apparatus 12b transmits a charge end signal to the charging apparatus 11. Next, the charging control apparatus 12b moves the vehicle 20c to an exit space not shown in FIG. 12 by driving the pallet moving part 16. Then the charging control apparatus 12b moves the vehicle 20b to the charging space to charge the vehicle (refer to the right drawing of FIG. 12). After the vehicle 20b has been fully charged, the charging control apparatus 12b moves the vehicle 20a to the charging space to charge the vehicle.

As described, according to the vehicle charging system of the present exemplary embodiment, the same effects as those of the first exemplary embodiment can be obtained. Compared with the first exemplary embodiment, an advantage of the second exemplary embodiment is that the order of charging can be freely changed since vehicles are not parked one at a time in succession. For instance, after the vehicle 20a has been charged first, the vehicle 20c or 20b may be charged. Further, the charging order may be determined according to a predetermined charging policy. For instance, vehicles can be charged in ascending/descending order of SOC. When vehicles are charged in ascending order of SOC (in descending order of the empty capacity of the rechargeable battery), the number of vehicles leaving the parking lot with a low SOC can be reduced.

Further, vehicles may be charged on a first-come-first-served basis in the present exemplary embodiment as well, or vehicles expected to leave the parking lot earlier may be charged first.

### Exemplary Embodiment 3

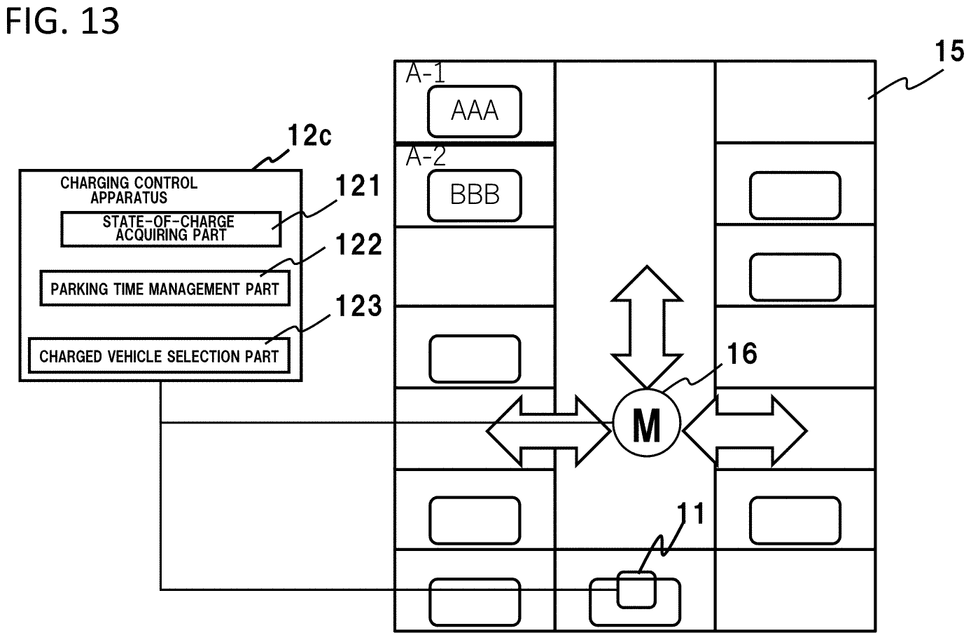

Next, a third exemplary embodiment in which the pallet is moved back and forth and left and right so that many vehicles can be parked will be described. FIG. 13 is a drawing illustrating the configuration of a parking lot system of the third exemplary embodiment of the present disclosure. Since the basic function of the third exemplary embodiment, which is to select a vehicle to be charged according to predetermined criteria and charge the vehicle, is the same as that of the first and the second exemplary embodiments, the differences from the first and the second exemplary embodiments will be mainly described below.

FIG. 13 shows a configuration in which the charging apparatus 11 is connected to a charging control apparatus 12c. This configuration differs from the first and the second exemplary embodiments in that the charging control apparatus 12c comprises a parking time management part 122 and a charged vehicle selection part 123 therein and that the pallets 15 are provided in a matrix and many vehicles can be accommodated. Further, although the example of FIG. 13 shows only one layer, it can be a multi-story parking lot with an elevator installed.

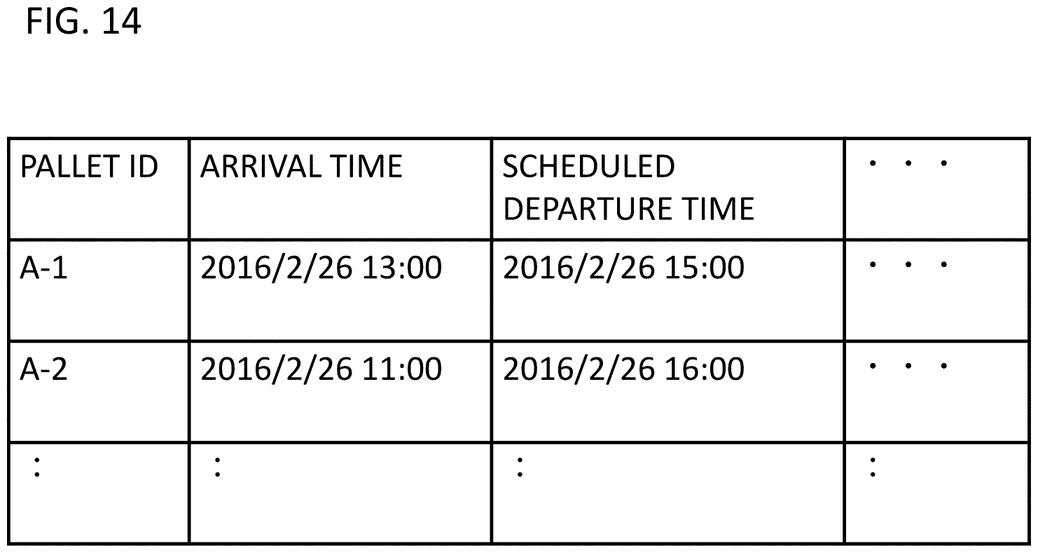

The parking time management part 122 manages the arrival time and payment status of each vehicle stored at an entrance/exit gate of the parking lot system. FIG. 14 is a drawing showing a table constituted by items used to select a vehicle to be charged, out of items managed by the parking time management pert 122. In the table in the example of FIG. 14, a plurality of entries that associate pallet IDs (parked vehicle IDs), arrival times (parking start time), and scheduled departure times of vehicles can be registered. For instance, the scheduled departure time can be calculated from the amount of the parking fee paid by the driver of a vehicle in advance. In a system in which the driver is required to pay when the vehicle leaves the parking lot, the scheduled departure time can be derived by adding a free parking period or the average parking period to the parking period. Further, the driver of the vehicle may be asked to explicitly provide the scheduled departure time or it may be estimated from the shopping status of the driver of the vehicle or his location information at a facility nearby the parking lot. If the scheduled departure time is estimated as described above, the parking time management part 122 or the charged vehicle selection part 123 will function as an estimating part configured to estimate the scheduled departure time.

The charged vehicle selection part 123 selects a vehicle to be charged using a SOC obtained by the state-of-charge acquiring part 121 and the information managed by the parking time management part 122. Further, the charged vehicle selection part 123 moves the selected vehicle to the charging space by driving the pallet moving part s 16. The charged vehicle selection part 123 returns the charged vehicle to its original location from the charging space.

Next, the operation of the present exemplary embodiment will be described in detail with reference to the drawings. For instance, it is assumed that vehicles AAA and BBB, each having a SOC of 50%, are mounted on pallets A-1 and A-2 in FIG. 13 and the information shown in FIG. 14 has been obtained.

In this case, since the vehicles AAA and BBB on the pallets A-1 and A-2 both have the SOC of 50%, the vehicles have the same priority in terms of SOC. The charged vehicle selection part 123 of the present exemplary embodiment first charges the vehicle BBB on the pallet A-2 having an earlier arrival time (parking start time) shown in FIG. 14. As a result of charging a vehicle having an earlier arrival time first, it is more likely that the vehicle BBB on the pallet A-2 will have been fully charged by the time it departs the parking lot. Similarly, in a case where three vehicles or more are parked, by charging vehicles in chronological order of the arrival time (parking start time), starting with the earliest, it becomes possible to charge as many vehicles as possible.

Further, a vehicle to be charged may be selected according to scheduled departure time, instead of the arrival time. In this case, the charged vehicle selection part 123 of the present exemplary embodiment first charges the vehicle AAA on the pallet A-1 having an earlier scheduled departure time shown in FIG. 14. As a result of charging a vehicle having an earlier scheduled departure time first, it is more likely that the vehicle AAA on the pallet A-1 will have been fully charged by the time it departs the parking lot. Similarly, in a case where three vehicles or more are parked, by charging vehicles in chronological order of the scheduled departure time, starting with the earliest, it becomes possible to charge as many vehicles as possible.

Further, the parking time of a vehicle may be estimated using both the arrival time and the scheduled departure time and a vehicle to be charged may be selected according to the parking time. For instance, when two vehicles have nearly identical SOC values and arrival times, one having an earlier scheduled departure time will have a shorter parking time. Therefore, by selecting vehicles having earlier scheduled departure times, it becomes possible to charge as many vehicles as possible. According to this system, for instance, if the current time is 14:00 and the vehicle on the pallet A-1 must be charged first in order for it to be fully charged, the vehicle AAA on the pallet A-1 will be selected and charged first on the basis of the scheduled departure time. Similarly, in a case where three vehicles or more are parked, by charging vehicles in ascending order of the parking time, it becomes possible to charge as many vehicles as possible. On the other hand, there are some cases where vehicles should not be charged in ascending order of the parking time such as when the parking times are extremely short. For instance, it may be sensible not to charge vehicles with extremely short estimated parking times in a parking lot used by many drivers who park their vehicles for relatively short periods of time.

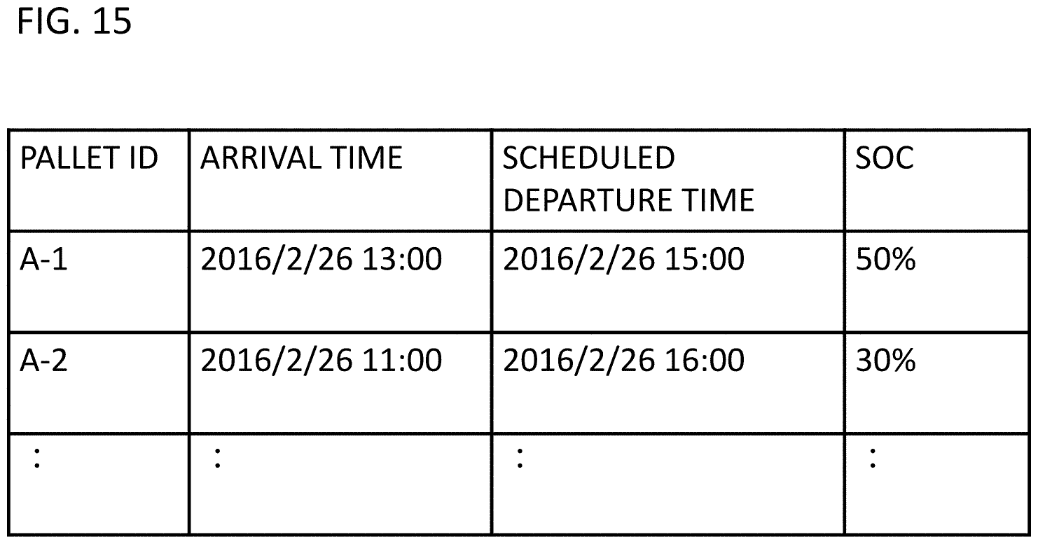

Further, in the present exemplary embodiment, the state-of-charge acquiring part 121 and the parking time management part 122 are provided separately, however, these may be integrated. In this case, a vehicle to be charged is selected using a table such as one shown in FIG. 15, and the charged vehicle selection part 123 may select a vehicle to be charged according to a predetermined policy in terms of the SOC, arrival time, and scheduled departure time. For instance, if a policy giving priority to vehicles with smaller SOC values is implemented, the vehicle on the pallet A-2 will be selected. By implementing such a policy, it becomes possible to reduce the number of vehicles that depart the parking lot with low SOC values.

On the other hand, in the case of a policy giving priority to vehicles having higher SOC values and requiring shorter charging time periods, the vehicle on the pallet A-1 is selected. By implementing such a policy, it becomes possible to increase the number of vehicles departing the parking lot fully charged. In a case where it takes time to charge a vehicle with a low SOC, this policy may be preferred since the driver would rather charge his vehicle quickly at an outside charging station.

Further, a vehicle to be charged may be selected according to the arrival time and the scheduled departure time, instead of the SOC. For instance, the vehicle on the pallet A-2 having an earlier arrival time can be selected from the pallets A-1 and A-2 in FIG. 15 as the vehicle to be charged. Similarly, the vehicle on the pallet A-1 having an earlier scheduled departure time can be selected from the pallets A-1 and A-2 in FIG. 15 as the vehicle to be charged.

Further, the charged vehicle selection part 123 may be given a function of predicting the time required for charging and a change (increase) in SOC due to charging on the basis of the SOC value and usage information of the charging apparatus. For instance, when the charged vehicle selection part 123 comprises the function of estimating the charging end time if a given vehicle is charged, the charged vehicle selection part 123 may determine that the vehicle should not be charged if the charging end time is later than the scheduled departure time, even when no other vehicles are waiting to be charged. Further, in this case, if there are other vehicles waiting to be charged, the charged vehicle selection part 123 may determine in what order the vehicles should be charged, considering the relationship with the vehicles waiting to be charged, even when the charging end time is earlier than the scheduled departure time.

Further, for instance, when the charged vehicle selection part 123 comprises the function of estimating a change (increase) in SOC at departure if a given vehicle is charged, the charged vehicle selection part 123 may determine whether or not the vehicle should be charged according to the amount of the change. For instance, the charged vehicle selection part 123 may decide to charge the vehicle if a 20% increase in SOC is possible or decide not to charge the vehicle if the estimated increase is less than that. It goes without saying that, in a case where the SOC is below a predetermined lower threshold value (for instance 30%), charging may be performed regardless of the estimated change (increase) in SOC.

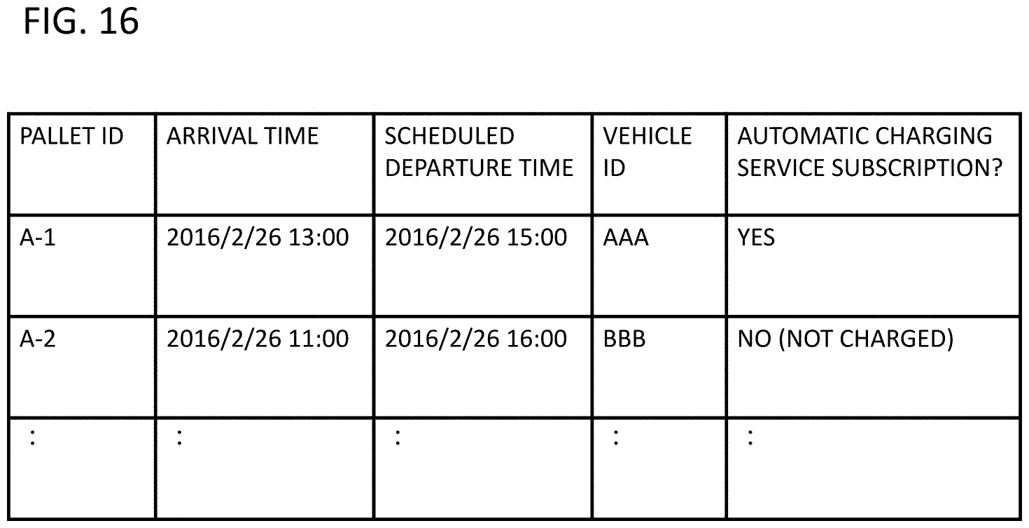

Further, if information relating to a vehicle can be acquired by communicating with a communication apparatus in the vehicle or acquired from an external vehicle condition management server (vehicle management cloud), a vehicle to be charged can be selected in a more detailed way. For instance, in a case where information indicating whether or not the owner or driver of the vehicle on each pallet subscribes to the automatic charging service of the present parking lot system can be obtained as shown in FIG. 16, a vehicle to be charged can be selected using this information. For instance, in the case of FIG. 16, the vehicle on the pallet A-1 is selected to be charged since the vehicle on the pallet A-2 does not subscribe to the automatic charging service of the present parking lot system.

Alternatively, in a case where the owners or drivers of vehicles subscribe to the automatic charging service of the present parking lot system and for instance set conditions such as the charging cost per unit or the capacity of the charging apparatus (charging time), a vehicle to be charged may be selected considering charging condition information, including whether or not there is a subscription to the automatic charging service, set by these users.

As described, the present disclosure can be applied to a mechanical parking lot system without problems. Further, this explanation was omitted in each exemplary embodiment described above, but it is desirable that, when the driver of a vehicle moves the vehicle to a pallet or parking space, a location where the vehicle should be parked be shown to the driver. For instance, it is effective to draw references within a pallet for aligning the power receiving coil 14 of the vehicle with the charging apparatus 11 or install wheel stoppers. This will facilitate alignment between the power receiving coil 14 of the vehicle and the charging apparatus 11 when the vehicle is moved to the charging space.

Further, the functions of the charging control apparatus used in each exemplary embodiment described above can be realized by a computer program having a computer that constitutes the charging control apparatus execute each processing described above using the hardware thereof. Further, in each exemplary embodiment described above, the state-of-charge acquiring part 121, the parking time management part 122, and the charged vehicle selection part 123 are provided within the charging control apparatus 12c, however, these may be physically independent.

Each exemplary embodiment of the present invention has been described, however, the present invention is not limited to these exemplary embodiments and further modifications, substitutions, and adjustments can be performed within the scope of the basic technological concept of the present invention. For instance, the network configuration shown in each drawing, the configuration of each element, and the expression of each message are examples to facilitate understanding of the present invention and are not limited to the configurations shown in the drawings.

Finally, preferred modes of the present invention will be summarized.

### [Mode 1]

(Refer to the vehicle charging system according to the first aspect.)

### [Mode 2]

In the vehicle charging system described above,
the charging control apparatus may sequentially charge rechargeable batteries of at least two vehicles by repeating the operation of selecting at least one vehicle from the plurality of vehicles and charging the selected vehicle.

### [Mode 3]

In the vehicle charging system described above,
the charging control apparatus may select the vehicle to be charged in descending order of the empty capacity of the rechargeable battery.

### [Mode 4]

The vehicle charging system described above may further comprise recording part configured to parking start times of the plurality of vehicles, and the charging control apparatus may select the vehicle to be charged by referring to the parking start time in addition to the state-of-charge.

### [Mode 5]

In the vehicle charging system described above,
the charging control apparatus may select the vehicle to be charged in chronological order of the parking start time, starting with the earliest.

### [Mode 6]

The vehicle charging system described above may further comprise an estimating part configured to estimate scheduled departure times of the plurality of vehicles, and the charging control apparatus may select the vehicle to be charged by referring to the scheduled departure time in addition to the state-of-charge.

### [Mode 7]

In the vehicle charging system described above,
the charging control apparatus may select the vehicle to be charged in chronological order of the scheduled departure time, starting with the earliest.

### [Mode 8]

The vehicle charging system described above may further comprise an estimating part configured to estimate parking times of the plurality of vehicles, and the charging control apparatus may select the vehicle to be charged by referring to the parking time.

### [Mode 9]

In the vehicle charging system described above,
the charging control apparatus may select the vehicle to be charged in descending order of the parking time.

### [Mode 10]

The vehicle charging system described above may further comprise predicting part configured to predict a state-of-charge of the rechargeable battery in the vehicle, and the charging control apparatus may select the vehicle to be charged on the basis of the predicted state-of-charge value at departure.

### [Mode 11]

The vehicle charging system described above may further comprise predicting part configured to predict a state-of-charge of the rechargeable battery in the vehicle, and the charging control apparatus may select the vehicle to be charged on the basis of how much the state-of-charge value is predicted to increase before the departure time.

### [Mode 12]

The vehicle charging system described above may further comprise an acquiring part configured to acquire charging condition information set by a user for the vehicle, and the charging control apparatus may select the vehicle to be charged by referring to the charging condition information in addition to the state-of-charge.

### [Mode 13]

(Refer to the parking lot system according to the second aspect.)

### [Mode 14]

(Refer to the vehicle charging method according to the third aspect.) Further, Modes 13 and 14 can be developed into Modes 2 to 12 as Mode 1.

Further, the disclosure of each Patent Literature cited above is incorporated herein in its entirety by reference thereto. It should be noted that other objects, features and aspects of the present invention will become apparent in the entire disclosure and that modifications may be done without departing the gist and scope of the present invention as disclosed herein and claimed as appended herewith. Also, it should be noted that any combination of the disclosed and/or claimed elements, matters and/or items may fall under the modifications. Particularly, the ranges of the numerical values used in the present description should be interpreted as a numeric value or small range example included in these ranges even in cases where no explanation is provided.

1. A vehicle charging system comprising:
a non-contact charging apparatus that performs non-contact charging on a rechargeable battery of a vehicle by facing a power receiving coil mounted on the vehicle;
a state-of-charge acquisition part configured to acquire a state-of-charge of rechargeable batteries in a plurality of vehicles; and
a charging control apparatus that selects a vehicle to be charged from the plurality of vehicles on the basis of the state-of-charge, moves the charging apparatus and/or the vehicle, and controls the charging operation of the charging apparatus.

2. The vehicle charging system according to claim 1, wherein
the charging control apparatus sequentially charges rechargeable batteries of at least two vehicles by repeating the operation of selecting at least one vehicle from the plurality of vehicles and charging the selected vehicle.

3. The vehicle charging system according to claim 2, wherein
the charging control apparatus selects the vehicle to be charged in descending order of the empty capacity of the rechargeable battery.

4. The vehicle charging system according to claim 1, further comprising a recording part configured to record parking start times of the plurality of vehicles, wherein
the charging control apparatus selects the vehicle to be charged by referring to the parking start time in addition to the state-of-charge.

5. The vehicle charging system according to claim 4, wherein
the charging control apparatus selects the vehicle to be charged in chronological order of the parking start time, starting with the earliest.

6. The vehicle charging system according to claim 1, further comprising an estimating part configured to estimate scheduled departure times of the plurality of vehicles, wherein
the charging control apparatus selects the vehicle to be charged by referring to the scheduled departure time in addition to the state-of-charge.

7. The vehicle charging system according to claim 6, wherein
the charging control apparatus selects the vehicle to be charged in chronological order of the scheduled departure time, starting with the earliest.

8. The vehicle charging system according to claim 1, comprising an estimating part configured to estimate parking times of the plurality of vehicles, wherein
the charging control apparatus selects the vehicle to be charged by referring to the parking time.

9. The vehicle charging system according to claim 8, wherein
the charging control apparatus selects the vehicle to be charged in descending order of the parking time.

10. The vehicle charging system according to claim 1, further comprising a predicting part configured to predict a state-of-charge of the rechargeable battery in the vehicle, wherein
the charging control apparatus selects the vehicle to be charged on the basis of the predicted state-of-charge value at departure.

11. The vehicle charging system according to claim 1, further comprising a predicting part configured to predict a state-of-charge of the rechargeable battery in the vehicle, wherein
the charging control apparatus selects the vehicle to be charged on the basis of how much the state-of-charge value is predicted to increase before the departure time.

12. The vehicle charging system according to claim 1, further comprising an acquiring part configured to acquire charging condition information set by a user for the vehicle, wherein
the charging control apparatus selects the vehicle to be charged by referring to the charging condition information in addition to the state-of-charge.

13. A parking lot system comprising:
a non-contact charging apparatus that performs non-contact charging on a rechargeable battery of a vehicle by facing a power receiving coil mounted on the vehicle;
a vehicle moving part configured to move a parked vehicle;
a state-of-charge acquisition part configured to acquire a state-of-charge of rechargeable batteries in a plurality of vehicles; and
a charging control apparatus that selects a vehicle to be charged from the plurality of vehicles on the basis of the state-of-charge, moves the vehicle, and controls the charging operation of the charging apparatus.

14. A vehicle charging method comprising:
having a non-contact charging apparatus that performs non-contact charging on a rechargeable battery of a vehicle by facing a power receiving coil mounted on the vehicle and a charging control apparatus capable of changing the relative position thereof with respect to the vehicle acquire a state-of-charge of rechargeable batteries in a plurality of vehicles;
having the charging apparatus and the charging control apparatus select a vehicle to be charged from the plurality of vehicles on the basis of the state-of-charge; and
having the charging apparatus and the charging control apparatus move the charging apparatus and/or the vehicle and control the charging operation of the charging apparatus.

15. The vehicle charging system according to claim 2, further comprising a recording part configured to record parking start times of the plurality of vehicles, wherein
the charging control apparatus selects the vehicle to be charged by referring to the parking start time in addition to the state-of-charge.

16. The vehicle charging system according to claim 3, further comprising a recording part configured to record parking start times of the plurality of vehicles, wherein
the charging control apparatus selects the vehicle to be charged by referring to the parking start time in addition to the state-of-charge.

17. The vehicle charging system according to claim 2, further comprising an estimating part configured to estimate scheduled departure times of the plurality of vehicles, wherein
the charging control apparatus selects the vehicle to be charged by referring to the scheduled departure time in addition to the state-of-charge.

18. The vehicle charging system according to claim 3, further comprising an estimating part configured to estimate scheduled departure times of the plurality of vehicles, wherein
the charging control apparatus selects the vehicle to be charged by referring to the scheduled departure time in addition to the state-of-charge.

19. The vehicle charging system according to claim 4, further comprising an estimating part configured to estimate scheduled departure times of the plurality of vehicles, wherein
the charging control apparatus selects the vehicle to be charged by referring to the scheduled departure time in addition to the state-of-charge.

20. The vehicle charging system according to claim 5, further comprising an estimating part configured to estimate scheduled departure times of the plurality of vehicles, wherein
the charging control apparatus selects the vehicle to be charged by referring to the scheduled departure time in addition to the state-of-charge.

21. The vehicle charging system according to claim 2, comprising an estimating part configured to estimate parking times of the plurality of vehicles, wherein
the charging control apparatus selects the vehicle to be charged by referring to the parking time.
